(19) United States
(12) Patent Application Publication
(10) Pub. No.: US 2002/0009264 A1
(43) Pub. Date: Jan. 24, 2002

(54) Waveguide structure having enhanced coupling with optical fibers

(76) Inventors: Emil S. Koteles, Ottawa (CA); Jian-Jun He, Ottawa (CA); Michael Davies, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 09/880,916

(22) Filed: Jun. 15, 2001

Related U.S. Application Data
(60) Provisional application No. 60/211,980, filed on Jun. 16, 2000.
(60) Provisional application No. 60/211,962, filed on Jun. 16, 2000.

(51) Int. Cl. G02B 6/26

(52) U.S. Cl. 385/43; 385/50; 385/131

(57) ABSTRACT

A waveguide structure having a homogeneous core material and opposing cladding layers is proposed wherein the waveguide core is substantially thick providing polarization independence and wherein a coupling port of the waveguide core is characterized in that it has an expanded mode for better coupling to fibre. A method is presented for producing such an expanded core.

### FIELD OF THE INVENTION

The invention relates generally to optical waveguides and more particularly to a thick optical waveguide that is approximately polarization independent.

### BACKGROUND OF THE INVENTION

Fibre optic communication systems have gained widespread acceptance over the past few decades. With the advent of optical fibre, communication signals are transmitted as light propagating along a fibre supporting total internal reflection of the light propagating therein. Many communication systems rely on optical communications because they are less susceptible to noise induced by external sources and are capable of supporting very high speed carrier signals and increased bandwidth. Unfortunately, optical fibre components are bulky and often require hand assembly resulting in lower yield and higher costs. O ne modem approach to automating manufacture in the field of communications is integration. Integrated electronic circuits (ICs) are well known and their widespread use in every field is a clear indication of their cost effectiveness and robustness. A similar approach to optical communication components could prove very helpful.

When using bulk optics, light is propagated along a glass fibre having a doped core and an undoped or differently doped cladding. The difference in index of refraction between the core and the cladding confines the light propagating within the fibre and thereby guides it. It is preferred that the core and cladding be somewhat symmetrical. Typically, the core is round and the cladding is about equal thickness thereabouts forming a concentric circle with the core. As such, light propagating within the core sees little polarization dependent effects.

In an attempt to integrate optical components, manufacturers try to miniaturise optical systems within a single chip. For example, a glass structure can be formed on a substrate and can act as a waveguide for conducting an optical signal. Typically, the waveguide structure is thin and acts as a two dimensional waveguide, thereby effecting polarization of a signal guided therein.

Unfortunately, many typical optical components are not easily integrated due to the differences between integrated planar waveguide component technologies and fibre technologies. Also, fibre is still used to communicate light over long distances, and as such, integrated devices often must be coupled to fibres to receive and provide optical signals. This only acts to render compatibility between optical fibres and planar waveguide devices more important than ever.

Presently, there is substantial promise in implementing waveguides within semiconductor material. These materials allow for integration of active and passive devices within a same physical component. However, semiconductor waveguides are different from their glass equivalents, and as such, new techniques for implementing existing components and for replacing existing manufacturing processes are necessary. For example, a waveguide formed in semiconductor material is often produced using layers of different material to provide a refractive index contrast between the waveguide core and its cladding. Alternatively, relative differences in dopant concentrations can provide small index differences that are often sufficient to provide guiding. Unfortunately, doping of the core to raise its index of refraction, results in lossy guiding regions which are not suitable in today's marketplace. Doping of the cladding layers, is also possible and presently shows much more promise.

It would be advantageous to provide an integrated waveguide device that is more compatible for interfacing with existing optical fibres.

### OBJECT OF THE INVENTION

It is an object of the invention to provide a semiconductor waveguide structure for improving the fiber-waveguide coupling efficiency.

### SUMMARY OF THE INVENTION

In an attempt to overcome these and other limitations of the prior art, there is provided a waveguide structure comprising:

a substrate formed of a doped semiconductor material; and,

a thick waveguide disposed on the substrate and in contact therewith formed of a same semiconductor material having a thickness of at least 2 μm and an index of refraction higher than that of the substrate and having a port at one end, the core of the waveguide near the port having a larger cross sectional area and having a reduced contrast in index of refraction between the core layer and the substrate for improving coupling of light propagating from a core of an optical fibre.

In accordance with another embodiment of the invention there is provided a waveguide structure comprising:

a substrate;

a waveguide formed of a material having an index of refraction substantially higher from that of the substrate disposed on the substrate and in contact therewith and having a port at one end, the core of the waveguide near the port having a larger cross sectional area and a reduced contrast in index of refraction for improving coupling of light propagating from a core of an optical fibre; and,

a layer of material similar in index of refraction to the substrate material and disposed about the waveguide core.

In accordance with another aspect of the invention there is provided a method of producing a waveguide structure comprising the steps of:

provide a semiconductor waveguide structure having a doped cladding layer and wherein the core layer is less doped than the cladding layer;

causing a diffusion of dopants within the cladding layer into the core layer at an endface of the waveguide such that at least a region adjacent the core layer is formed having a lower index of refraction than the core and a higher index of refraction than the cladding layer, the cross sectional area of the region decreasing further from the endface..

### BRIEF DESCRIPTION OF THE DRAWINGS

Exemplary embodiments of the invention, will now be described, in conjunction with the drawings, in which:

FIG. 1 is a prior art schematic diagram of a TEC fibre;

FIG. 2 is a simplified prior art diagram of a glass waveguide having an expanded core region;

FIG. 3 is cross sectional view of a prior art thin waveguide structure;

FIG. 4 is a cross sectional view of a prior art thick waveguide structure;

FIG. 5 (a and b) are simplified cross-sectional diagrams of thick waveguides sandwiched between confining layers according to the invention;

FIG. 6 is a simplified cross sectional diagram of a method of improving coupling efficiency between the waveguide structure and a fibre by blurring regions proximate a port of the waveguide to affect the interface between materials;

FIG. 7 is a simplified diagram of an etched waveguide;

FIG. 8 is a simplified diagram of a waveguide of undoped material surrounded by doped material;

FIG. 9 is a diagram of a four step process to manufacture a waveguide as shown in FIG. 9; and,

FIG. 10 is a simplified diagram of a waveguide with its mode confined by implanted ions within the waveguide material.

### DETAILED DESCRIPTION OF THE INVENTION

An InP structure can be formed on a substrate and can act as a waveguide for conducting an optical signal. Such a structure is commonly referred to as a semiconductor waveguide device. Historically, the waveguide structure is thin and acts as a two dimensional waveguide, thereby effecting polarization of a signal guided therein. In order to provide polarization independence, several approaches exist.

A major disadvantage of present waveguide devices is the coupling inefficiencies when coupled to optical fibres. Because the core of an optical fibre is substantially larger than the core within a waveguide structure coupling losses are significant. Attempts to produce waveguides with very large cores have resulted in poorly confined optical signals and tremendous difficulties in forming waveguide paths within the core material. Etching of vertical smooth surfaces is very difficult for very thick waveguides. As such, prior art attempts at forming waveguide structures to overcome the coupling losses have failed.

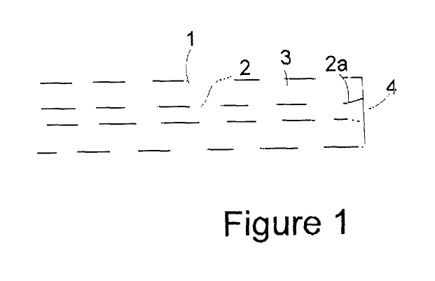

TEC (Thermally expanded core) fibre is well known in the art. Referring to FIG. 1, a diagram of a TEC fibre is shown. A TEC fibre 1 is shown having a core 2 and a cladding 3. The core 2 is formed by doping the central region of the fibre. The doped core reduces the index of refraction within the core resulting in guiding of light therein due to the difference in the index of retraction between the core and the cladding layer. In order to result in a TEC fibre 1 as shown application of heat results in an expanded guiding region—core 2a. TEC fibres are fabricated by heating the end 4 of a fibre 1 to cause the core dopants to diffuse and increase the core size 2a. This results in a larger diameter optical beam that emerges from the fibre end and therefore having a smaller divergence angle. TEC fibre has found many applications and is used where a smooth core size transition is advantageous.

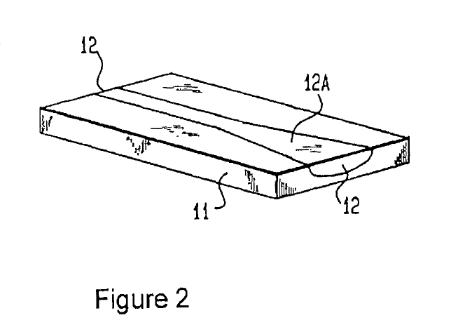

Similarly, the technology has been applied to glass waveguide structures. In U.S. Pat. No. 4,886,538, assigned to Polaroid and incorporated herein by reference, a doped waveguide in glass as shown in FIG. 2 is disclosed that, upon application of heat, expands to improve coupling efficiency with an optical fibre. According to the patent, when the doped core is heated, diffusion of the dopant results in an expansion of the doped core thereby increasing the cross sectional area of the guiding region. Expansion, as is shown in the reference occurs laterally. Such a device is analogous to the TEC fibre technology using a doped core and then promoting ion diffusion from the core. The device, however, suffers the known drawbacks relating to, for example, polarization sensitivity due to its planar and unsymmetrical nature.

Currently, a trend toward semiconductor waveguides is forming. Using semiconductor material such as InP allows for integration of active and passive components on a same waveguide substrate. To form a guiding region within a material such as InP it is possible to dope the core with dopant for increasing the index of refraction therein and thereby to avail oneself of the prior art methods of expanding the core. Unfortunately, doping of the core region results in waveguides, which are often too lossy to be practical.

In order to form practical waveguides using semiconductor materials, the cladding layers are doped and the core layer is undoped. As such, using the prior art method of diffusing dopants within the core is not possible to increase the overall cross section of the core guiding region. Of course, as indicated above, increasing the cross sectional area of the core is advantageous and therefore, a method of doing so would be advantageous.

Also, in the method disclosed in the above referenced patent, increasing the cross sectional area of the core results in a more unsymmetrical core cross section which is undesirable for well known reasons such as polarization sensitivity. Conversely, the TEC fibre core expands in an approximately symmetrical fashion as the dopants diffuse outward from the centrally disposed core.

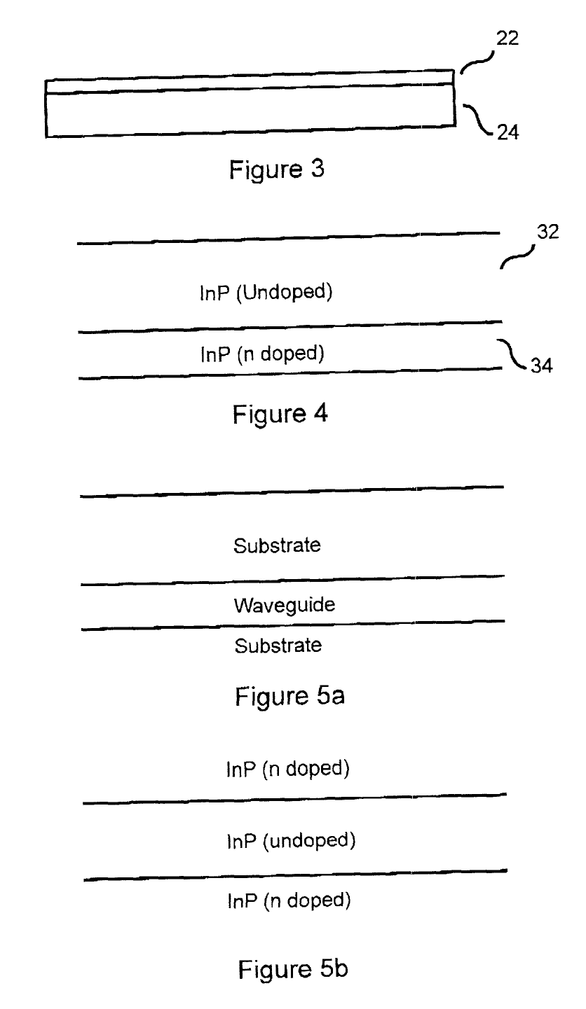

Referring to FIG. 3, a waveguide according to the prior art is shown in cross section. A substantially thin waveguide core layer 22 is formed on a substrate 24. A signal propagating in the core layer does not propagate in a polarization independent manner. This is evident due to the planar (two dimensional) nature of the waveguide.

Referring to FIG. 4, a thick waveguide formed of InP is shown. A doped substrate layer of InP 34 acts as a cladding layer for an undoped core layer of InP. Etching of the undoped layer results in waveguides on that layer. As described in the article by Gini et al., supra, the thick waveguide has an elliptical mode providing for much less polarization dependence than the thin waveguide of FIG. 3. Though this is the case, the device is not truly polarization independent and is asymmetrical, a property that affects polarization independence in specific and light propagation in general.

Referring to FIG. 5(a), a waveguide similar to that of FIG. 4 is shown but now a third layer of material in the form of substrate material is deposited on the InP waveguide core. Of course other core materials are useful with the present invention. The choice of InP was made because it facilitates integration of the optical waveguide device with active components at 1.55 microns. The third layer is of a material similar to that of the substrate. As such the core appears symmetrical to optical signals propagating therein having a same interface on opposing sides. Referring to FIG. 5(b), a waveguide is shown formed of undoped InP sandwiched between two layers of doped InP. The undoped region acts to conduct light therein confined by the doped layers. Typically, the undoped region is about 3 μm. Of course thicker or thinner layers are possible, but care should be taken when expanding the thickness to ensure that the waveguide is single mode in the direction of the thickness and when making the layer thinner that polarisation independence is sufficient for a desired application. Once again, because the cladding layers are nearly identical on opposing sides of the waveguide, the resulting symmetry provides for excellent polarisation independence when used in conjunction with a thick guiding layer. Further, etching is used to confine the mode to specific regions and thereby to form waveguides. Of course, attempts to confine the mode into a circular region will further enhance polarisation independence of such a device.

Advantageously, a wider mode waveguide has increased coupling efficiency. It is proposed that coupling efficiency can be further enhanced by widening an end of the waveguide to form a port for coupling with a fibre. Several methods are proposed for achieving such a device.

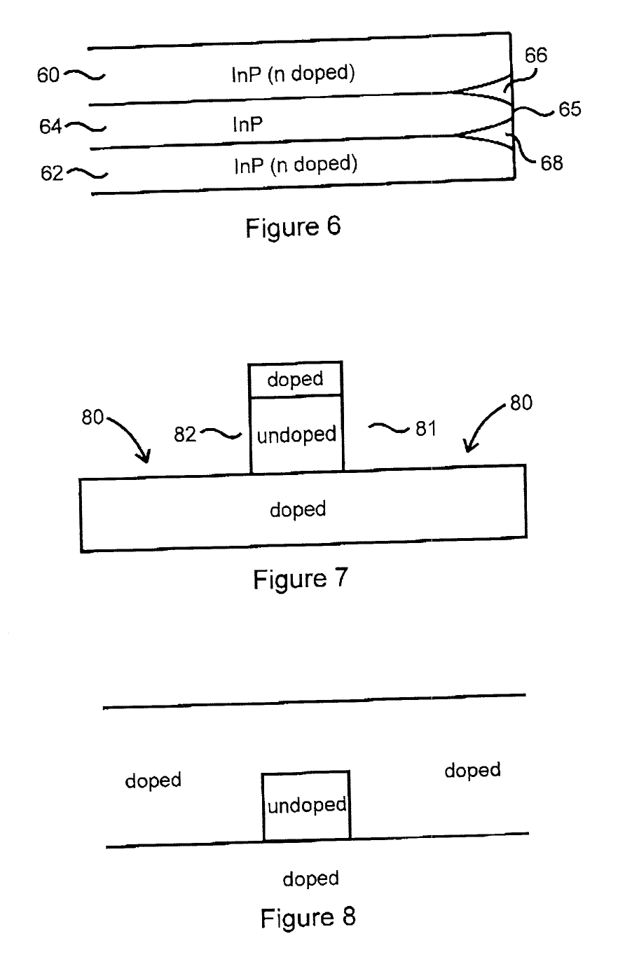

Referring to FIG. 6, a thick InP waveguide structure is shown wherein diffusion has been effected at a port thereof in order to affect do pant concentrations thereabout. As shown, this results in three different doped regions. The region 64 is the waveguide region for conducting optical signals. The regions 60 and 62 act to confine the optical signals to the region 64. At the port 65, two regions 66 and 68 are formed through the process of diffusion and having lower dopant concentrations than the regions 60 and 62 but more dopants than region 64. As such, the edges of the optical path are softened and, as is shown in the diagram, light coupled thereto is confined to the core of the waveguide. Such a funnel like structure increases coupling efficiency. Of course, in the lateral direction etching can be used to form a similar funnel like cross section prior to or after diffusion.

Referring to FIG. 7, a typical thick waveguide 82 is shown etched. As is evident, a substantial amount of material is necessarily removed from regions 80 in the etching process and smooth vertical surfaces 81 are highly advantageous but difficult to achieve. Thus, another method of confining the optical signal within the waveguide for use with a thick waveguide is desirable.

Referring to FIG. 8, an etched waveguide similar to that of FIG. 8 is shown with an overgrowth of doped InP surrounding the entire waveguide structure. This provides for symmetry of the waveguide structure along each direction—horizontal and vertical. As is evident to those of skill in the art. Application of diffusion to the dopants within the cladding layers now results in a more symmetric transition expanding in all directions in a similar fashion. Though the undoped region is initially square, some blurring at the corners due to dopant movement occurs and the resulting guiding region is somewhat rounded. This results in approximate polarization independence.

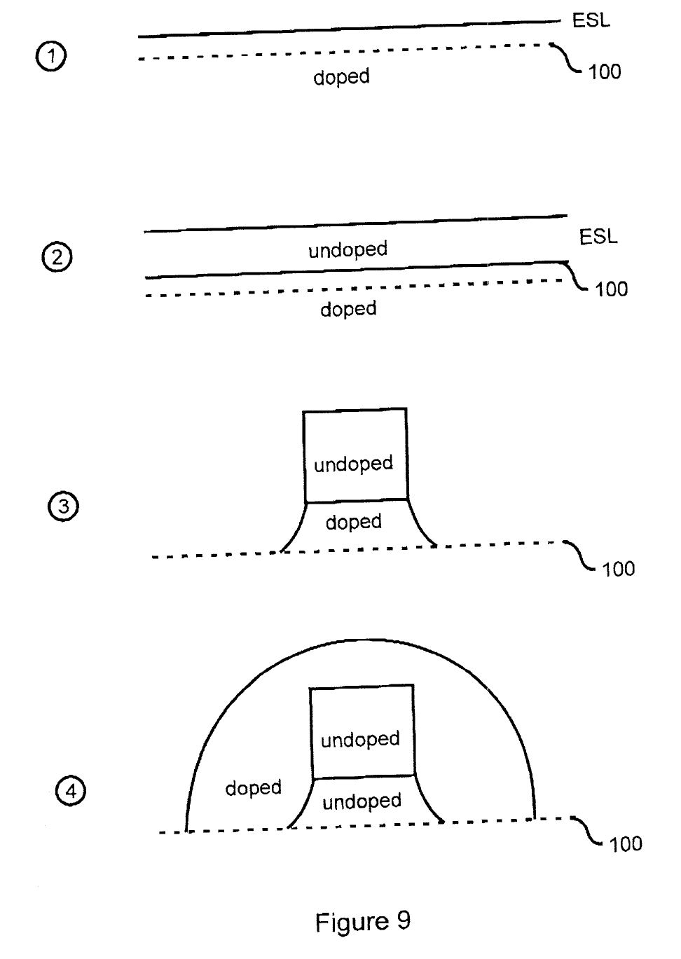

Referring to FIG. 9, a number of simple diagrams are presented showing different stages in forming such a waveguide structure when using, for example InP. First, a doped layer is grown. Within the doped layer is an etch stop layer 100 for causing an etching process to stop at a particular location. Then an undoped layer is grown on the doped layer. The undoped layer is preferably a thick undoped layer according to the invention. In a third step, die waveguide is dry etched to etch out a mode confining region. A wet etch is then applied to etch the material away down to the etch stop layer.

In the fourth step shown, an overgrowth of doped waveguide material is performed to cover the entire waveguide structure with a confining layer. The resulting waveguide is symmetrical in terms of cladding at all interfaces. When coupling into or from fibre, the method is useful in generating cladded funnel like ports such as those of FIG. 6 for increasing coupling efficiency.

As such, the advantages of the TEC fibre of the prior art are now possible within semiconductor waveguide material.

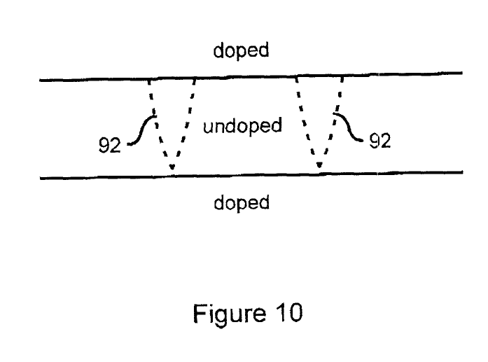

Referring to FIG. 10, a thick waveguide according to the invention is shown having ions 92 implanted therein to confine an optical signal within a region between walls of implanted ions. Such a process is practical in (GaAs and InP and some other waveguide materials and is reasonably predicted to be practicable in many waveguide materials in the next few years. The use of such an implantation eliminates many of the drawbacks to thick waveguide structures. Preferably, the implantation of ions is performed before the upper confining layer is deposited on the waveguide core. This reduces the necessary implantation depth while retaining the advantageous symmetry of the waveguide core.

Several methods of implantation exist. One is described below though any number of known methods or those discovered may be used. Accordingly, a small amount of Tin is included within SiO₂ deposited at two points on a GaAs waveguide structure. The As is draw out of the waveguide and is replaced by the Tin as implantation progresses. The cross section of the waveguide so formed is not quite square as some spread occurs in the implanted ions as the depth increases. That said, it is likely sufficiently square Lo confine the mode accurately. Once ion implantation is complete, the doped layer for confining the optical signal and for providing symmetry according to the invention is grown on the waveguide layer.

Though the invention is described with reference to InP and GaAs waveguide structures, it is applicable with necessary limitations and modifications to other waveguide materials. Semiconductors are preferable for implementation of the invention as doping of semiconductors is well known in the art. For example III-V compounds such as GaAs are well suited to implementing the invention. It is also predicted that group IV semiconductors such as silicon are well suited to implementation of the invention therein.

Of course, the method of widening the core for increasing coupling efficiency is applicable to a core clad on opposing sides, a core clad about the core, and to a prior art core resting on a substrate and clad only on that side.

Numerous other embodiments can be envisaged without departing from the spirit or scope of the invention.

What is claimed is:

1. A waveguide structure comprising:
a substrate formed of a doped semiconductor material; and,
a thick waveguide disposed on the substrate and in contact therewith formed of a same semiconductor material having a thickness of at least 2 μm and an index of refasction higher than that of the substrate and having a port at one end, the core of the waveguide near the port having a larger cross sectional area and having a reduced contrast in index of refraction between the core layer and the substrate for improving coupling of light propagating from a core of an optical fibre.

2. A waveguide structure according to claim 1 further comprising:
a cladding layer of doped semiconductor material similar in index of refraction to the substrate material,
said layer of material disposed about the waveguide core.

3. A waveguide structure according to claim 2 wherein
the thick waveguide structure has a loss substantially indepent of polarization.

4. A waveguide structure according to claim 2 wherein:
the substrate and cladding are doped and the core is substantially undoped.

5. A waveguide structure according to claim 4 wherein:
the cladding layer is formed by an overgrowth step after the waveguide has been formed and wherein the increased cross section is formed by a step of diffusion such that diffusion occurs for increasing the cross sectional area along two orthogonal dimensions and for reducing the contrast in index of refraction.

6. A waveguide structure according to claim 4 wherein: the thick waveguide core includes a channel waveguide formed by doping the waveguide on opposing sides of the core in a lateral dimension, and wherein the increased cross section is formed by a step of diffusion such that diffusion occurs for increasing the cross sectional area along two orthogonal dimensions.

7. A waveguide structure comprising:
a substrate;
a waveguide formed of a material having an index of refraction substantially higher from that of the substrate disposed on the substrate and in contact therewith and having a port at one end, the core of the waveguide near the port having a larger cross sectional area and a reduced contrast in index of refraction for improving coupling of light propagating from a core of an optical fibre; and,
a layer of material similar in index of refraction to the substrate material and disposed about the waveguide core.

8. A waveguide structure according to claim 7 wherein
the waveguide structure is substantially polarization independent

9. A waveguide structure according to claim 7 wherein:
the waveguide is made from a semiconductor material and wherein the substrate and cladding are doped and the core is substantially undoped.

10. A waveguide structure according to claim 9 wherein:
the cladding layer is formed by an overgrowth step after the waveguide has been formed and wherein the increased cross section is formed by a step of diffusion such that diffusion occurs for increasing the cross sectional area along two orthogonal dimensions.

11. A waveguide structure according to claim 4 wherein:
the core is a channel waveguide formed by doping the waveguide on opposing sides of the core in a lateral dimension and wherein the increased cross section is formed by a step of diffusion such that diffusion occurs for increasing the cross sectional area along two orthogonal dimensions.

12. A method of producing a waveguide structure comprising the steps of:
provide a semiconductor waveguide structure having a doped cladding layer and wherein the core layer is less doped than the cladding layer;
causing a diffusion of dopants within the cladding layer into the core layer at an endface of the waveguide such that at least a region adjacent the core layer is formed having a lower index of refraction than the core and a higher index of refraction than the cladding layer, the cross sectional area of the region decreasing further from the endface.

13. A method of producing a waveguide structure as defined in claim 12 wherein the core layer is approximately undoped.

14. A method of producing a waveguide structure as defined in claim 12 wherein the cladding layer comprises the substrate.

15. A method of producing a waveguide structure as defined in claim 14 wherein cladding layer comprises another layer on an opposing side of the core layer from the substrate.

16. A method of producing a waveguide structure as defined in claim 15 wherein the cladding layer is about the core layer

17. A method of producing a waveguide structure as defined in claim 16 wherein the cladding layer is formed by an overgrowth step after the waveguide has been formed.

18. A method of producing a waveguide structure as defined in claim 14 wherein the core is a channel waveguide formed by doping the core layer on opposing sides of the core in a lateral dimension to form a portion of the core layer having a higher index of refraction and another portion of the core layer having a lower index of refraction.

19. A method of producing a waveguide structure as defined in claim 18 wherein
